(19) United States
(12) Patent Application Publication
(10) Pub. No.: US 2025/0263314 A1
(43) Pub. Date: Aug. 21, 2025

(54) ELECTROLYTIC REMOVAL OF NITROGEN FROM WATER

(71) Applicant: NuQuatic, LLC, St. Paul, MN (US)

(72) Inventors: Carlos Borras, Ruskin, FL (US); Donald A. Luke, Valrico, FL (US)

(21) Appl. No.: 18/858,458

(22) PCT Filed: Apr. 20, 2023
(86) PCT No.: PCT/US2023/019295

§ 371 Date: Oct. 21, 2024

Related U.S. Application Data
(60) Provisional application No. 63/333,605, filed on Apr. 22, 2022.

(51) Int. Cl. C02F 1/467; C02F 1/461; C02F 101/16

(52) U.S. Cl. CPC C02F 1/4674; C02F 1/46109; C02F 2001/46128; C02F 2001/46142; C02F 2101/163; C02F 2101/166; C02F 2201/46115

(57) ABSTRACT

Apparatuses and methods of using the same for removal of nitrogen from water. An apparatus for removal of nitrogen from water includes an electrolytic cell that includes an anode, a cathode, and two or more bipolar electrodes positioned between the anode and the cathode.

### CROSS-REFERENCE TO RELATED APPLICATION

This application claims the benefit of priority to U.S. Provisional Patent Application Ser. No. 63/333,605 filed Apr. 22, 2022, the disclosure of which is incorporated herein in its entirety by reference.

### BACKGROUND

Nitrogen is a common constituent of agricultural fertilizers, manure, and organic wastes in sewage and industrial effluent. It is an essential element for plant life. However, when there is too much nitrogen in water, it can cause growth of plants and algae and can deplete oxygen from the water at a rate that is greater than ecosystems can handle, causing severe ecological effects including toxic algae blooms, death of native aquatic species, and loss of biodiversity (eutrophication). Simple particulate removal processes such as filtration will remove particulates and lower the total nitrogen concentration; however, these processes will not lower the concentration of water-soluble forms of nitrogen. Although various methods for removal of soluble nitrogen from water are available, these methods are expensive, complex, and difficult to control.

### SUMMARY OF THE INVENTION

The present invention provides an apparatus for removal of nitrogen from water. The apparatus includes an electrolytic cell that includes an anode, a cathode, and two or more bipolar plates that are positioned between the anode and the cathode.

The present invention provides an apparatus for removal of nitrogen from water. The apparatus includes an electrolytic cell that includes an anode plate including titanium, wherein the anode plate includes a catalyst coating including TiO₂, RuO₂, and IrO₂. The electrolytic cell includes a cathode plate including titanium. The electrolytic cell also includes two or more bipolar electrode plates positioned between the anode and the cathode. Major faces of the anode, cathode, and bipolar plates are parallel to one another. Each bipolar plate includes a catalyst coating on one major face thereof that is facing the cathode plate. The catalyst coating includes TiO₂, RuO₂, and IrO₂. The other major face of each bipolar plate is free of catalyst coatings or includes another catalyst coating having a different composition than the catalyst coating that is on the major face that is facing the cathode plate.

The present invention provides an apparatus for removal of nitrogen from water. The apparatus includes a first electrolytic cell including a first anode plate including titanium, wherein the first anode plate includes a catalyst coating including TiO₂, RuO₂, and IrO₂. The first electrolytic cell includes a first cathode plate including titanium. The first electrolytic cell also includes two or more first bipolar plates positioned between the first anode plate and the first cathode plate. Major faces of the first anode plate, first cathode plate, and first bipolar plates are parallel to one another. Each first bipolar plate includes a catalyst coating on one major face thereof that is facing the first cathode plate. The catalyst coating includes TiO₂, RuO₂, and IrO₂. The other major face of each first bipolar plate is free of catalyst coatings or includes another catalyst coating having a different composition than the catalyst coating that is on the major face that is facing the first cathode plate. The apparatus also includes a second electrolytic cell that includes the first cathode plate, two or more second bipolar plates, and a second anode plate, wherein the second anode plate includes a catalyst coating including the catalyst coating. The second bipolar plates are between the first cathode plate and the second anode plate. Major faces of the first cathode plate, second bipolar plates, and the second anode plate are parallel to one another. Each second bipolar plate includes the catalyst coating on one major face thereof that is facing the first cathode plate. The other major face of each second bipolar plate is free of catalyst coatings or includes another catalyst coating having a different composition than the catalyst coating that is on the major face that is facing the first cathode plate.

The present invention provides an apparatus for removal of nitrogen from water. The apparatus includes a first electrolytic cell including a first anode plate including titanium, wherein the first anode plate includes a catalyst coating including TiO₂, RuO₂, and IrO₂. The first electrolytic cell includes a first cathode plate including titanium. The first electrolytic cell also includes two or more first bipolar plates positioned between the first anode plate and the first cathode plate. Major faces of the first anode plate, first cathode plate, and first bipolar plates are parallel to one another. Each first bipolar plate includes a catalyst coating on one major face thereof that is facing the first cathode plate. The catalyst coating includes TiO₂, RuO₂, and IrO₂. The other major face of each first bipolar plate is free of catalyst coatings or includes another catalyst coating having a different composition than the catalyst coating that is on the major face that is facing the first cathode plate. The apparatus also includes a second electrolytic cell including the first anode plate, two or more second bipolar plates, and a second cathode plate. The second bipolar plates are between the first anode plate and the second cathode plate. Major faces of the first anode plate, second bipolar plates, and second cathode plate are parallel to one another. Each second bipolar plate includes the catalyst coating on one major face thereof that is facing the second cathode plate. The other major face of each second bipolar plate is free of catalyst coatings or includes another catalyst coating having a different composition than the catalyst coating that is on the major face that is facing the second cathode plate.

The present invention provides a method of removal of nitrogen from water. The method includes immersing in water including nitrogen the electrolytic cell of the apparatus for removal of nitrogen from water described herein. The method also includes applying an electrical potential across the anode and the cathode of the electrolytic cell, to form nitrogen gas and to form product water having a lower concentration of nitrogen than the water including nitrogen.

The present invention provides a method of removal of nitrogen from water. The method includes immersing an electrolytic cell in water including nitrogen, wherein the water includes ammonia and/or ammonium ions, and the water further includes chloride ions. The electrolytic cell includes an anode plate including titanium, wherein the anode plate includes a catalyst coating including TiO₂, RuO₂, and IrO₂. The electrolytic cell includes a cathode plate including titanium. The electrolytic cell includes two or more bipolar electrode plates positioned between the anode and the cathode. Major faces of the anode, cathode, and bipolar plates are parallel to one another. Each bipolar plate includes a catalyst coating on one major face thereof that is facing the cathode plate. The catalyst coating includes TiO₂, RuO₂, and IrO₂. The other major face of each bipolar plate is free of catalyst coatings or includes another catalyst coating having a different composition than the catalyst coating that is on the major face that is facing the cathode plate. The method also includes applying an electrical potential across the anode plate and the cathode plate of the electrolytic cell, to form nitrogen gas and to form product water having a lower concentration of nitrogen than the water including nitrogen.

The apparatus of the present invention for removal of nitrogen from water, and the method of using the same, has various advantages over other apparatuses and methods of using the same. For example, in various aspects, the two or more bipolar plates of the electrolytic cell of the present invention can enable highly efficient conversion of ammonium and/or ammonia to nitrogen gas via formation of chlorine and/or hypochlorite from chloride in water, such as by producing a concentration of chlorine and/or hypochlorite that that is two to three times greater than possible with a electrolytic cell that lacks a bipolar plate or that only has one bipolar plate, resulting in a greater rate of treatment. In various aspects, the present invention can remove nitrates and/or nitrites from water, such as by reduction to ammonia and/or ammonium and subsequent reaction of the ammonia and/or ammonium with hypochlorite produced in the electrolytic cell. In various aspects, the present invention incorporates a pH control system that can prevent acidic conditions that raise the risk of producing toxic materials.

### BRIEF DESCRIPTION OF THE FIGURES

The drawings illustrate generally, by way of example, but not by way of limitation, various aspects of the present invention.

FIG. 1 illustrates an electrolytic cell, in accordance with various aspects of the present invention.

FIG. 2 illustrates two electrolytic cells, in accordance with various aspects of the present invention.

FIG. 3 illustrates two electrolytic cells, in accordance with various aspects of the present invention.

FIG. 4 illustrates a plurality of electrolytic cells, in accordance with various aspects of the present invention.

FIG. 5A illustrates a side view of a plurality of electrolytic cells in accordance with various aspects of the present invention.

FIG. 5B illustrates a front view of a plurality of electrolytic cells in accordance with various aspects of the present invention.

FIG. 5C illustrates a top view of a plurality of electrolytic cells in accordance with various aspects of the present invention.

FIG. 5D illustrates a view showing the front, side, and top of a plurality of electrolytic cells in accordance with various aspects of the present invention.

FIG. 6 illustrates three arrays of 10 electrolytic cells in accordance with various aspects of the present invention.

FIG. 7 illustrates a close-up of 10 electrolytic cells in accordance with various aspects of the present invention.

FIG. 8 illustrates chlorine concentration versus time during electrolysis using an electrolytic cell with two bipolar plates, in accordance with various aspects of the present invention.

FIG. 9 illustrates pH versus electrical charge used during electrolysis using an electrolytic cell with two bipolar plates.

FIG. 10 illustrates ammonia concentration versus electrical charge used during electrolysis using an electrolytic cell with two bipolar plates.

### DETAILED DESCRIPTION OF THE INVENTION

subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Reference will now be made in detail to certain aspects of the disclosed Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

In various aspects, salts having a positively charged counterion can include any suitable positively charged counterion. For example, the counterion can be ammonium (NH₄⁺), or an alkali metal such as sodium (Na⁺), potassium (K⁺), or lithium (Li⁺). In some aspects, the counterion can have a positive charge greater than +1, which can in some aspects complex to multiple ionized groups, such as Zn²⁺, Al³⁺, or alkaline earth metals such as Ca²⁺ or Mg²⁺.

All concentrations of nitrogen, chloride, chlorine, ammonia, and ammonium referred to are dissolved concentrations of these materials in elemental or non-elemental (e.g., as a compound or ion including the material) forms, unless otherwise indicated. All concentrations given herein are by weight unless otherwise indicated.

As used herein, “total nitrogen” refers to the sum of nitrate-nitrogen (NO₃), nitrite-nitrogen (NO₂), ammonia-nitrogen (NH₃), and organically bonded nitrogen. Total nitrogen can be measured by summing the total Kjeldahl nitrogen (TKN), nitrate-nitrogen, and nitrite-nitrogen. Nitrate-nitrogen and nitrite-nitrogen can be measured by US-EPA 353.2, Revision 2.0: Determination of Nitrite-Nitrate Nitrogen by Automated Colorimetry. Total Kjeldahl nitrogen (TKN) which is the sum of ammonia-nitrogen plus organically bound nitrogen but does not include nitrate-nitrogen or nitrite-nitrogen. TKN can be measured by US-EPA 351.2, Revision 2.0: Determination of Total Kjeldahl Nitrogen by Semi-Automated Colorimetry.

Apparatus for Removal of Nitrogen from Water.

Various aspects of the present invention provide an electrolytic cell, or a plurality of electrolytic cells, for removal of nitrogen from water. Various aspects of the present invention provide an apparatus for removal of nitrogen from water, wherein the apparatus includes or is the electrolytic cell or plurality of electrolytic cells. The electrolytic cell can include an anode, a cathode, and two or more bipolar electrodes positioned between the anode and the cathode.

The anode, the cathode, and the bipolar electrodes can independently have any suitable physical form, such as a rod, screen, or a plate. The anode, the cathode, and the bipolar electrodes can each have the form of a plate wherein each of the plates are arranged parallel to one another. The anode plate, cathode plate, and bipolar plates can independently have any suitable thickness, such as 0.1 mm to 50 mm, 1 mm to 30 mm, or less than or equal to 50 mm and greater than or equal to 0.1 mm, 0.5, 1, 2, 3, 4, 5, 6, 7, 8, 9, 10, 12, 14, 16, 18, 20, 25, 30, 35, 40, or 45 mm. The anode plate, cathode plate, and bipolar plates can have different thicknesses or the same thicknesses.

The anode, the cathode, and the bipolar electrodes can be free of physical contact with one another. The anode, the cathode, and the bipolar electrodes can be free of electrical connection with one another, other than an optional aqueous liquid in which the electrolytic cell is immersed and an optional electrical potential applied across the anode and the cathode. The electrolytic cell can include a gap between the anode and the bipolar electrodes (e.g., the nearest of the two or more bipolar electrodes) and a gap between the cathode and the bipolar electrodes (e.g., the nearest of the two or more electrodes). The gaps can independently be any suitable size, such as 0.1 mm to 20 mm, 0.1 mm to 5 mm, or less than or equal to 20 mm and greater than or equal to 0.1 mm, 0.2, 0.3, 0.4, 0.5, 0.6, 0.8, 1, 1.2, 1.4, 1.6, 1.8, 2, 2.5, 3, 3.5, 4, 4.5, 5, 6, 7, 8, 9, 10, 12, 14, 16, or 18 mm. The electrolytic cell can include a gap between the bipolar electrodes, such as a gap of 0.1 mm to 20 mm, 0.1 mm to 5 mm, or less than or equal to 20 mm and greater than or equal to 0.1 mm, 0.2, 0.3, 0.4, 0.5, 0.6, 0.8, 1, 1.2, 1.4, 1.6, 1.8, 2, 2.5, 3, 3.5, 4, 4.5, 5, 6, 7, 8, 9, 10, 12, 14, 16, or 18 mm.

One or more of the anode, cathode, and bipolar plates can be held in place via any suitable means, such that gaps between the anode and bipolar plates, between the bipolar plates, and/or between the bipolar plates and the cathode are maintained. In various aspects, one or more non-conductive connectors can hold one or more of the anode, cathode, and bipolar plates together and/or in-place. For example, the electrolytic cell can include a non-conductive rod that passes through the bipolar plates and that also passes through one or both of the anode and cathode. The non-conductive rod can be formed from any suitable material, such as a plastic, or such as a conductive material (e.g., metal such as stainless steel) that is coated or otherwise covered with a non-conductive material (e.g., rubber or plastic). The non-conductive rod can be a threaded rod onto which one or more nuts can be threaded to prevent the anode, cathode, and bipolar plates from sliding longitudinally along the rod. The one or more non-conductive rods can connect and maintain the gap between the anode, the cathode, and the bipolar plates, and can hold multiple electrolytic cells together by passing therethrough.

The electrolytic cell can include two or more bipolar electrodes. The electrolytic cell can include two of the bipolar electrodes. The electrolytic cell can include three of the bipolar electrodes. The electrolytic cell can include three or more of the bipolar electrodes.

The anode of the electrolytic cell can be formed of any suitable material, such as titanium, stainless steel, graphite, a conductive carbon material, or a combination thereof. The anode can include titanium. The anode can include a catalyst coating, such as a coating on both major faces of an anode plate. The anode can be titanium with a catalyst coating thereon. The catalyst coating can be any suitable catalyst coating. The catalyst coating can include one or more transition metal oxides. The catalyst coating can include TiO₂, RuO₂, IrO₂, or a combination thereof (e.g., alloys thereof). The catalyst coating can include TiO₂, RuO₂, IrO₂, such as in a ratio of (50-90):(10-50):(0.1-20) or (60-80):(20-30):(1-6) TiO₂:RuO₂:IrO₂. The catalyst coating can include 70:27:3 TiO₂:RuO₂:IrO₂. The catalyst coating can include Cu/Co (e.g., an alloy of copper and cobalt). The catalyst coating can include Cu/Ni (e.g., an alloy of copper and nickel).

The cathode of the electrolytic cell can be formed of any suitable material, such as titanium, stainless steel, or a combination thereof. The cathode can include titanium, or can be titanium. The cathode can be free of coatings, such as catalyst coatings. The cathode can include a catalyst coating, such as a catalyst coating including Cu, Ag, Co, Ni, Fe, Mo, Cu/Co, Cu/Ni, or a combination thereof (e.g., alloys thereof).

The bipolar electrodes can include titanium, stainless steel, or a combination thereof. The bipolar electrodes can include titanium. The bipolar electrodes can be free of coatings, such as catalyst coatings. The bipolar electrodes can include a catalyst coating. The bipolar electrodes can be titanium electrodes with a catalyst coating thereon. The bipolar electrodes can include the catalyst coating on both major faces of bipolar plates. The bipolar electrodes can include the catalyst coating on one major face of each of the bipolar plates (e.g., the major face that faces the cathode) and the other face of each of the bipolar plates (e.g., the major face that faces the anode) can be free of catalyst coatings or can include a catalyst coating having a different composition than the catalyst coating on the other major face. The catalyst coating can be any suitable catalyst coating. The catalyst coating can include one or more transition metal oxides. The catalyst coating can include TiO₂, RuO₂, IrO₂, Cu, Ag, Co, Ni, Fe, Mo, Cu/Co, Cu/Ni, or a combination thereof (e.g., alloys thereof). The catalyst coating can include TiO₂, RuO₂, IrO₂, such as in a ratio of (50-90):(10-50):(0.1-20) or (60-80):(20-30):(1-6) TiO₂:RuO₂:IrO₂. The catalyst coating can include 70:27:3 TiO₂:RuO₂:IrO₂. The catalyst coating can include Cu/Co. The catalyst coating can include Cu/Ni. The bipolar plate can include one coating on the major face that faces the cathode (e.g., TiO₂, RuO₂, IrO₂, or a combination thereof) and a different coating on the major face that faces the anode (e.g., Cu, Ag, Co, Ni, Fe, Mo, or a combination thereof, such as Cu/Co and/or Cu/Ni).

When an electrical potential is applied across the anode and the cathode with the electrolytic cell immersed in water including chloride ions, the electrolytic cell can have a high sustained Faraday efficiency of chlorine production from the chloride ions, such as a Faraday efficiency of chlorine gas production from the chloride ions of 50% to 100%, 70% to 90%, or less than or equal to 100% and greater than or equal to 50, 55, 60, 65, 70, 72, 74, 76, 78, 80, 82, 84, 86, 88, 90, 92, 94, 96, or 98%.

When an electrical potential is applied across the anode and the cathode with the electrolytic cell immersed in water including chloride and ammonium ions and/or ammonia, the electrolytic cell can be effective to remove the ammonium ions and/or ammonia from the water in the form of nitrogen gas. For example, the chlorine and the ammonium ions and/or ammonia can react to form nitrogen gas. For example, the chlorine can form hypochlorite (e.g., via oxidation of chloride at the anode and hydrolysis of the resulting chlorine) that reacts with ammonium ions and/or ammonia to form nitrogen gas.

The apparatus can include a single one of the electrolytic cells. The apparatus can include a plurality of the electrolytic cells. For example, the apparatus can include 2 of the electrolytic cells, or 3, 4, 5, 6, 7, 8, 9, 10, 11, 12, 13, 14, 15, 16, 17, 18, 19, or 20 or more of the electrolytic cells. The apparatus can include 2 to 1,000 of the electrolytic cells.

The apparatus can include at least two of the electrolytic cells. The anode, cathode, and bipolar electrodes can be a first anode, a first cathode, and first bipolar electrodes, and the electrolytic cell can be a first electrolytic cell. The apparatus can further include a second electrolytic cell including the first cathode, two or more second bipolar electrodes, and a second anode, wherein the second bipolar electrodes are between the first cathode and the second anode. In various aspects, the apparatus further includes a third electrolytic cell including the second anode, two or more third bipolar electrodes, and a second cathode.

The anode, cathode, and bipolar electrodes can be a first anode, a first cathode, and first bipolar electrodes, and the electrolytic cell can be a first electrolytic cell. The apparatus can further include a second electrolytic cell including the first anode, two or more second bipolar electrodes, and a second cathode. The second bipolar electrodes are between the first anode and the second cathode. In various aspects, the apparatus further includes a third electrolytic cell including the second cathode, two or more third bipolar electrodes, and a second anode.

In various aspects, the apparatus further includes a pH control system that raises and/or maintains pH of water in which the electrolytic cell is immersed. For example, the pH control system can add base to the water, and optionally measures pH of the water.

The pH control system can prevent the pH from dropping so low that significant risk of formation of toxic materials is present. For example, the pH system can raise the pH of the water in which the electrolytic cell is immersed to, or maintain the pH at, 4 to 12, 5 to 8, or less than or equal to 12 and greater than or equal to 4, 4.5, 5, 5.5, 6, 6.5, 7, 7.5, 8, 8.5, 9, 9.5, 10, 10.5, 11, or 11.5.

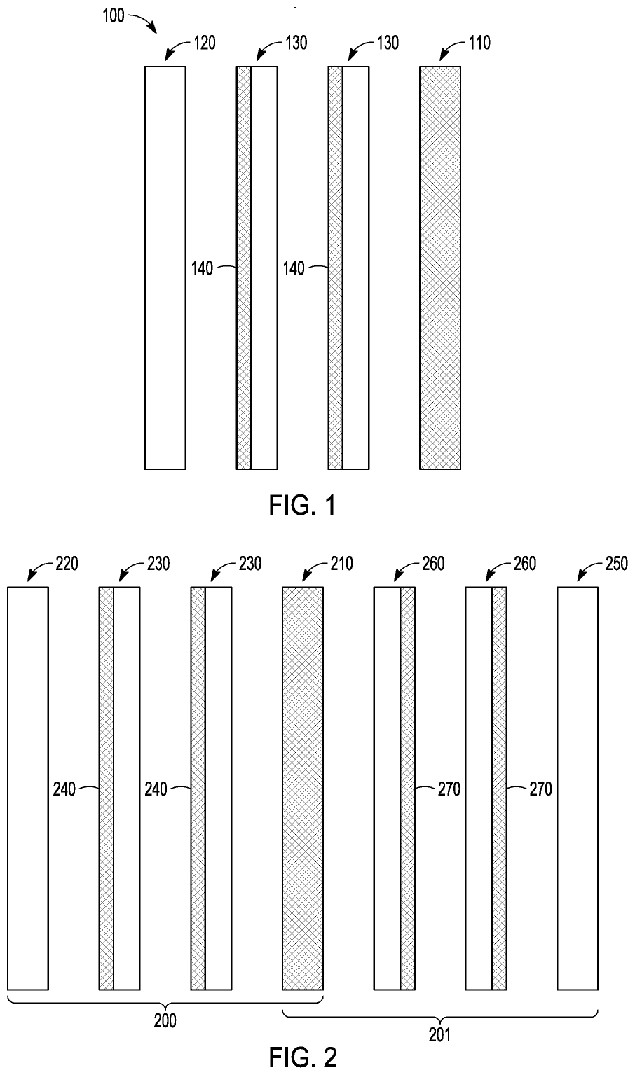

FIG. 1 illustrates an electrolytic cell 100. The electrolytic cell includes an anode plate 110. The electrolytic cell includes a cathode plate 120. The anode plate includes a catalyst coating. The electrolytic cell includes two bipolar plates 130 that are positioned between the anode plate 110 and the cathode plate 120. The two bipolar plates 130 each include a catalyst coating on one major face thereof 140 that is facing the cathode plate 120.

FIG. 2 illustrates two electrolytic cells include a first electrolytic cell 200 and a second electrolytic cell 201. The first electrolytic cell 200 includes a first cathode plate 220, a first anode plate 210, and two first bipolar plates 230 positioned between the first cathode plate 220 and the first anode plate 210. The first anode plate 210 includes a catalyst coating. The two first bipolar plates 230 includes a catalyst coating on one major face thereof 240 that is facing the first cathode plate 220. The second electrolytic cell 201 includes the first anode plate 210, a second cathode plate 250, and two second bipolar plates 260. The two second bipolar plates 260 each include a catalyst coating on one major face thereof 270 that is facing the second cathode plate 250.

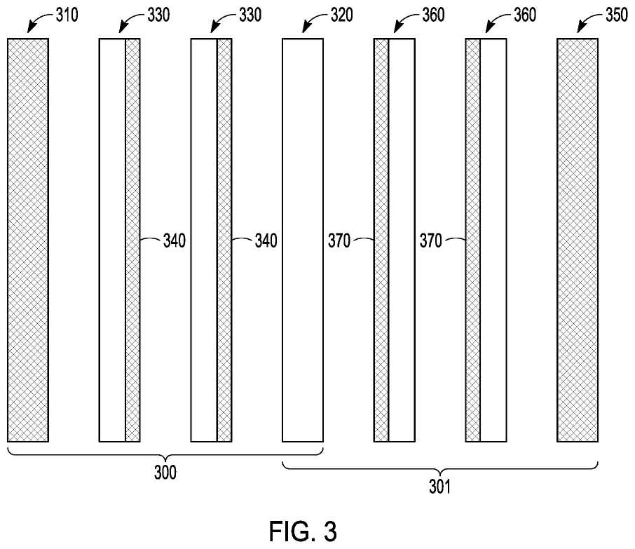

FIG. 3 illustrates two electrolytic cells including a first electrolytic cell 300 and a second electrolytic cell 301. The first electrolytic cell 300 includes a first anode plate 310, a first cathode plate 320, and two first bipolar plates 330 positioned between the first anode plate 310 and the first cathode plate 320. The first anode plate 310 includes a catalyst coating. The two first bipolar plates 330 include a catalyst coating on one major face thereof 340 that is facing the first cathode plate 320. The second electrolytic cell 301 includes the first cathode plate 320, a second anode plate 350, and two second bipolar plates 360. The second bipolar plates 360 are between the first cathode plate 320 and the second anode plate 350. The second anode plate 350 includes a catalyst coating. The second bipolar plates 330 each include a catalyst coating on one major face thereof 370 that is facing the first cathode plate 320.

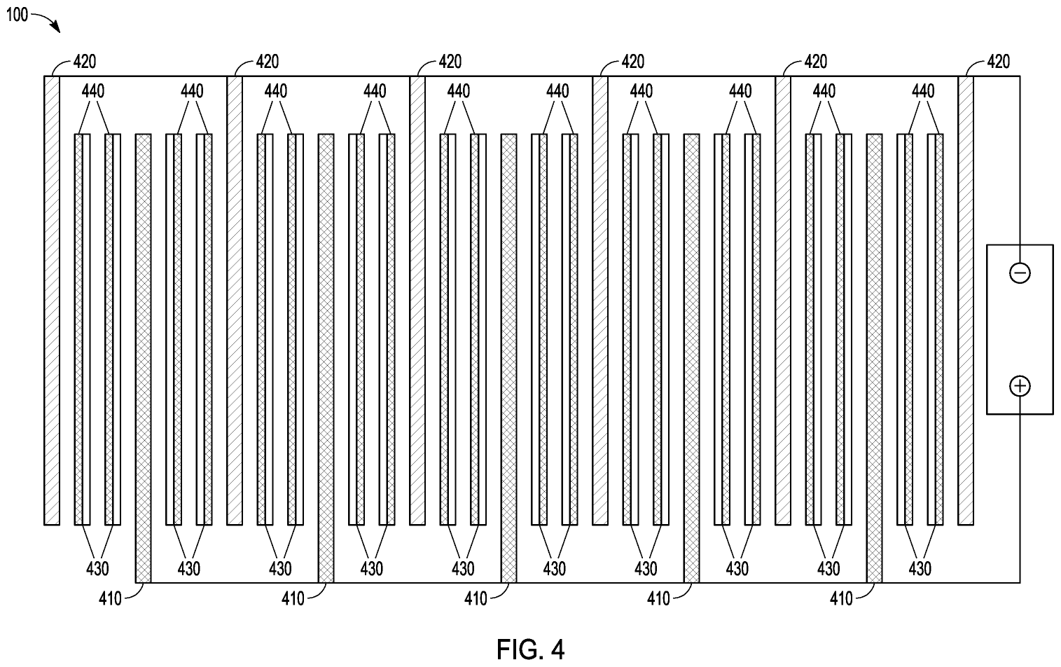

FIG. 4 illustrates a plurality of electrolytic cells 400. Each electrolytic cell includes an anode 410, a cathode 420, and two bipolar plates 430. The anode 410 includes a catalyst coating. The bipolar plates each include a catalyst coating on a major face thereof 440 that faces the nearest cathode 420. FIG. 4 illustrates 10 electrolytic cells.

Method of Removal of Nitrogen from Water.

In various aspects, the present invention provides a method of removal of nitrogen from water. The method includes immersing the electrolytic cell described herein, or a plurality of the electrolytic cells, in water including nitrogen. The water can include nitrogen in the form of ammonia and/or ammonium. The water can further include chloride ions. The electrolytic cell can be partially or fully submerged/immersed in the water. The method can include applying an electrical potential across the anode and the cathode of the electrolytic cell, to form nitrogen gas and to form product water having a lower concentration of nitrogen than the water including nitrogen.

The electrical potential can be a monopolar electrical potential that generates a DC current in the electrolytic cell. The electrical potential can be alternating polarity such that the electrical potential generates an AC current in the electrolytic cell. The method can include operating the electrolytic cell, and applying sufficient potential across the anode and cathode, that the electrolytic cell has any suitable density, such as 0.001-0.1 A/cm², 0.02-0.04 A/cm², or 0.001 A/cm² or more, or less than, equal to, or greater than 0.005, 0.01, 0.015, 0.02, 0.025, 0.03, 0.035, 0.04, 0.045, 0.05, 0.06, 0.07, 0.08, 0.09, or 0.1 A/cm² or less.

The water including nitrogen can include chloride ions and ammonium ions and/or ammonia. The water including nitrogen can have any suitable concentration of ammonia and/or ammonium ions, such as 50 ppm to 5,000 ppm, 150 ppm to 400 ppm, or 50 ppm or more, or less than, equal to, or greater than 100 ppm, 150, 200, 250, 300, 350, 400, 450, 500, 600, 750, 1,000, 2,000, 3,000, 4,000, or 5,000 ppm or less. The water including nitrogen can have any suitable concentration of chloride ions, such as 50 ppm to 40,000 ppm, 200 ppm to 10,000 ppm, or 50 ppm or more, or less than, equal to, or greater than 100 ppm, 200, 500, 1,000, 2,000, 4,000, 6,000, 8,000, 10,000, 15,000, 20,000, 30,000, or 40,000 ppm or less. The method can further include adding chloride ions to the water including nitrogen (e.g., via addition of a chloride salt such as sodium and/or potassium chloride), such as adding sufficient chloride ions to accomplish a concentration of chloride ions of 50 ppm to 40,000 ppm, 200 ppm to 10,000 ppm, or 50 ppm or more, or less than, equal to, or greater than 100 ppm, 200, 500, 1,000, 2,000, 4,000, 6,000, 8,000, 10,000, 15,000, 20,000, 30,000, or 40,000 ppm or less.

The water including nitrogen can have any suitable pH, such as a pH of 4 to 12, 5 to 8, or less than or equal to 12 and greater than or equal to 4, 4.5, 5, 5.5, 6, 6.5, 7, 7.5, 8, 8.5, 9, 9.5, 10, 10.5, 11, or 11.5. The method can include adding one or more bases to the water including nitrogen to regulate pH of the water, such as by raising or maintaining a pH of the water. For example, the addition of the one or more bases to the water including nitrogen can be sufficient to accomplish a pH of 4 to 12, 5 to 8, or less than or equal to 12 and greater than or equal to 4, 4.5, 5, 5.5, 6, 6.5, 7, 7.5, 8, 8.5, 9, 9.5, 10, 10.5, 11, or 11.5.

The product water can have any suitable total nitrogen concentration, dissolved nitrogen concentration, or a combination thereof, of 0 ppm to 2 ppm, or 0 ppm to about 1 ppm, or about 0 ppm, or less than, equal to, or greater than 0.001 ppm, 0.0012, 0.0014, 0.0016, 0.0018, 0.0020, 0.0022, 0.0024, 0.0026, 0.0028, 0.0030, 0.0032, 0.0034, 0.0036, 0.0038, 0.0040, 0.0045, 0.0050, 0.0060, 0.0080, 0.01, 0.02, 0.04, 0.06, 0.08, 0.1, 0.2, 0.4, 0.6, 0.8, 1, 1.1, 1.2, 1.4, 1.6, 1.8, or about 2 ppm or less.

The product water can remove any suitable amount of the ammonia and/or ammonium ions from the water including nitrogen, such as 80% to 100%, or 99% to 100%, or 80% to 100%, 99-100%, or 80% or more, or less than, equal to, or greater than 81%, 82, 83, 84, 85, 86, 87, 88, 89, 90, 91, 92, 93, 94, 95, 96, 97, 98, 99, 99.9, 99.99, or 99.999% or less.

The product water can reduce total nitrogen concentration, dissolved nitrogen concentration, or a combination thereof to any suitable percentage of that of the water including nitrogen, such as 0% to 70% of the respective total nitrogen concentration, dissolved nitrogen concentration, or a combination thereof, of the water including nitrogen, or about 0% to about 30%, or about 0%, or less than, equal to, or greater than about 0.001%, 0.005, 0.01, 0.05, 0.1, 0.5, 1, 2, 4, 6, 8, 10, 15, 20, 25, 30, 35, 40, 45, 50, 55, 60, 65, or about 70% or more.

The method can produce any suitable concentration of hypochlorite from chloride in the water including nitrogen, such as 100 ppm to 20,000 ppm, or 2000 ppm to 2,500 ppm, or more, or less than, equal to, or greater than 200 ppm, 400, 600, 800, 1,000, 1,200, 1,400, 1,600, 1,800, 2,000, 2,100, 2,200, 2,300, 2,400, 2,500, 2,600, 2,800, 3,000, 4,000, 6,000, 8,000, 10,000, 15,000, or 20,000 ppm or less. The method is not limited to any particular mechanism of removing nitrogen from the water as ammonia using the electrolytic cell. The removing of nitrogen as nitrogen gas can include converting ammonia and or ammonium in the water to nitrogen gas using the electrolytic cell. Passing the water through the electrolytic nitrogen removal stage can produce hypochlorite in the water (e.g., via oxidation of chloride ions to chlorine at the anode, which is hydrolyzed to form hypochlorite), which can react with ammonia and/or ammonium in the water to form the nitrogen gas, which can be released to the environment. The reaction can described as NH₄⁺+1.5 HOCl→0.5 N₂+1.5H₂O+2.5H⁺+1.5 Cl⁻. Passing the water through the electrolytic nitrogen removal stage can produce chlorine gas in the water which can react with ammonia and/or ammonium in the water to form nitrogen gas, which can be released to the environment. The reaction can be described as 2NH₄⁺+3Cl₂→N₂+6Cl⁻+8H⁺.

The product water can have any suitable chloride concentration, such as a chloride concentration of 1 ppm to 40,000 ppm, or 50 ppm to 10,000 ppm, or such as 50 ppm to 40,000 ppm, 200 ppm to 10,000 ppm, or 50 ppm or more, or less than, equal to, or greater than 100 ppm, 200, 500, 1,000, 2,000, 4,000, 6,000, 8,000, 10,000, 15,000, 20,000, 30,000, or 40,000 ppm or less.

The product water can have any suitable pH, such as a pH of 4 to 12, 5 to 8, or less than or equal to 12 and greater than or equal to 4, 4.5, 5, 5.5, 6, 6.5, 7, 7.5, 8, 8.5, 9, 9.5, 10, 10.5, 11, or 11.5.

The method can provide a Faraday efficiency of chlorine gas production from chloride ions in the water including nitrogen of 50% to 100%, 70% to 90%, or less than or equal to 100% and greater than or equal to 50, 55, 60, 65, 70, 72, 74, 76, 78, 80, 82, 84, 86, 88, 90, 92, 94, 96, or 98%.

The method can include circulating and/or agitating and/or shearing the water including the nitrogen in which the electrolytic cell is immersed, which can help to dislodge bubbles on the anode, cathode, and/or bipolar electrodes and can increase contact between the water and the anode, cathode, and bipolar electrodes.

The electrolytic cell can be a flow-through cell, and the method can include continuously flowing the water including nitrogen passed the cell at a rate that allows for the desired extent of nitrogen removal. The water can optionally be recirculated after exiting the cell for continued passes through the cell with a recirculation rate that provides the desired extent of nitrogen removal. In a method including recirculation, the term “product water” can refer to the water after it has been recirculated through the cell one or more times.

The method can process the water including nitrogen into the product water at any suitable rate. For example, the method can process the water including nitrogen into the product water at a rate of 1 gallon per minute (GPM) to 1,000,000 CPM, or 10 GPM to 100,000 GPM, or 100 GPM to 5,000 GPM.

The method can remove nitrogen in the form of ammonia and/or ammonium from the water including the nitrogen at any suitable rate, such as 0.01 kWh/kg N removed to 200 kWh/kg, or 1 kWh/kg to 100 kWh/kg, or 30 kWh/kg to 50 kWh/kg, or less than or equal to 200 kWh/kg and greater than or equal to 0.01, 0.05, 0.1, 0.5, 1, 1.5, 2, 2.5, 3, 4, 5, 6, 8, 10, 12, 14, 16, 18, 20, 22, 24, 26, 28, 30, 32, 34, 36, 38, 40, 42, 44, 46, 48, 50, 55, 60, 65, 70, 80, 90, 100, or 150 kWh/kg. The method can include releasing the nitrogen gas to the atmosphere.

In various aspects, the method can remove nitrates (NO₃⁻) and/or nitrites (NO₂⁻) from the water including the nitrogen. The method is not limited to any particular mechanism of removing nitrates and/or nitrites using the electrolytic cell. In various aspects, nitrates and/or nitrites can be reduced (e.g., at the cathode) to form ammonia and/or ammonium. The ammonia and/or ammonium can then react with hypochlorite produced in the electrolytic cell (e.g., via oxidation of chloride ions at the anode to form chlorine which is hydrolyzed to form hypochlorite), to form nitrogen gas. In various aspects, the nitrate and/or nitrite is removed without producing nitrous oxide, or with greater production of nitrogen than nitrous oxide.

The method can include immersing a single one of the electrolytic cells in the water including nitrogen. The method can include immersing a plurality of the electrolytic cells in the water including nitrogen.

### EXAMPLES

Various aspects of the present invention can be better understood by reference to the following Examples which are offered by way of illustration. The present invention is not limited to the Examples given herein.

In the Examples, an apparatus including a plurality of electrolytic cells was used. The apparatus included an anode section, a cathode section, and a bipolar section. The sections were fastened together and insulated by a 30 mm nylon rod. The anode and cathode sections were connected via a 165 mm×382 mm×6.4 mm ASTM Grade 1 titanium plate and had a vertical 165 mm×600 mm×6.4 mm ASTM Grade 1 titanium bus bar for connection to the power supply.

The anode section included 5 titanium plates, had dimensions of 410 mm×660 mm×2 mm, and had an active anode surface area per section of 2.5 m². The cathode section included 6 titanium plates, had dimensions of 410 mm×660 mm×2 mm, and had an active cathode surface area per section of 2.5 m². The bipolar section included 20 titanium plates and had an active surface area per bi-polar plate of 10 m² (5 m² anode surface, and 5 m² cathode surface). The anode included a catalyst coating that was 70:27:3 TiO₂:RuO₂:IrO₂. The bipolar plates also included the catalyst coating on a major face thereof that faces the nearest cathode plate, with the other major face of the bipolar plates being free of catalyst coatings.

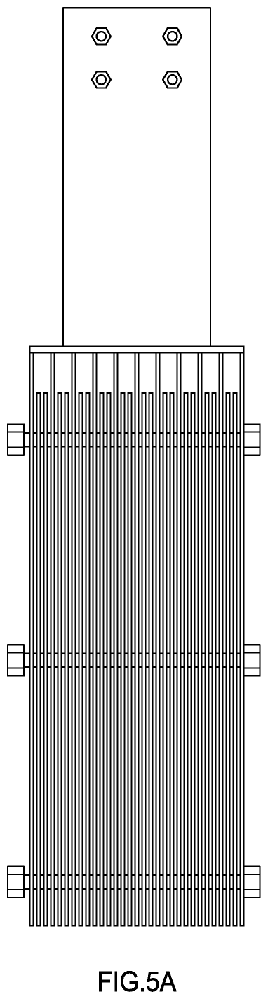

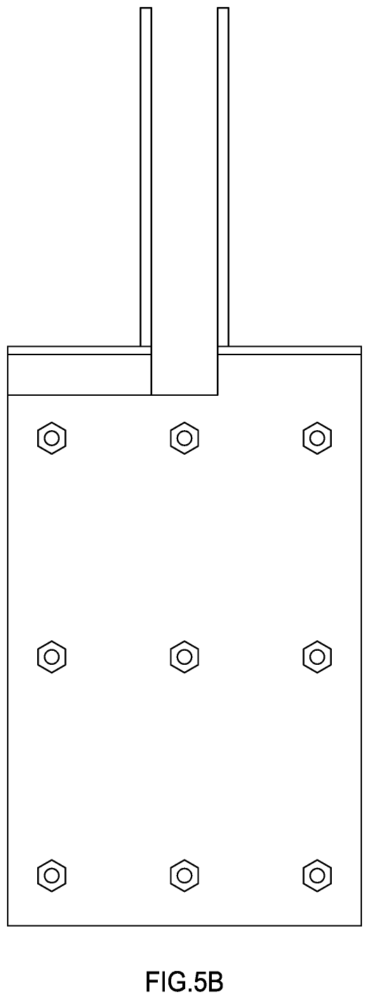

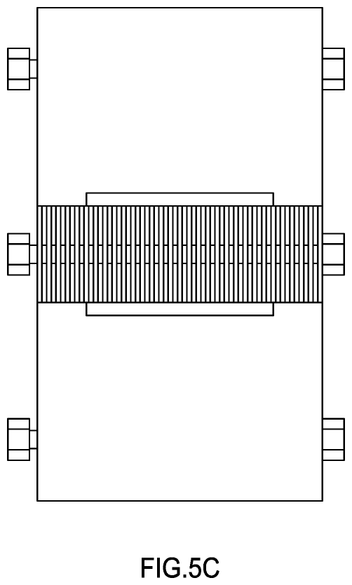

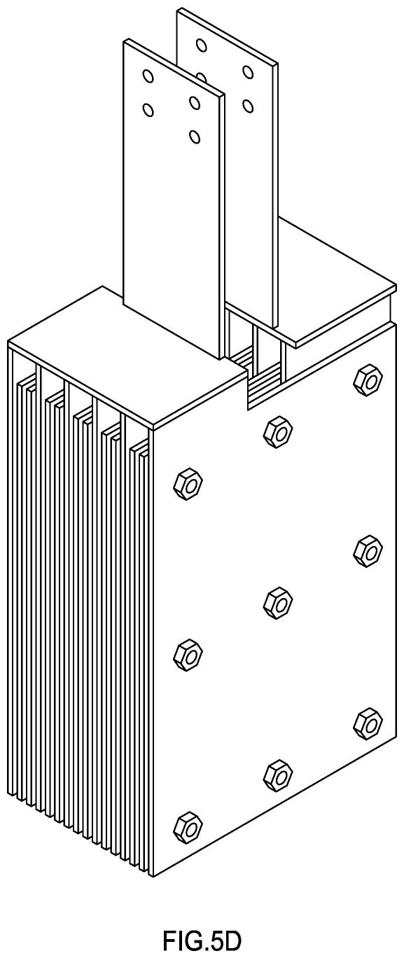

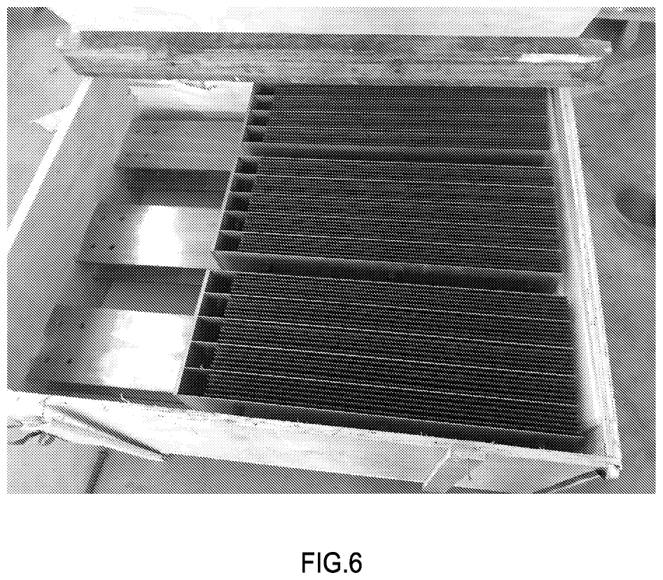

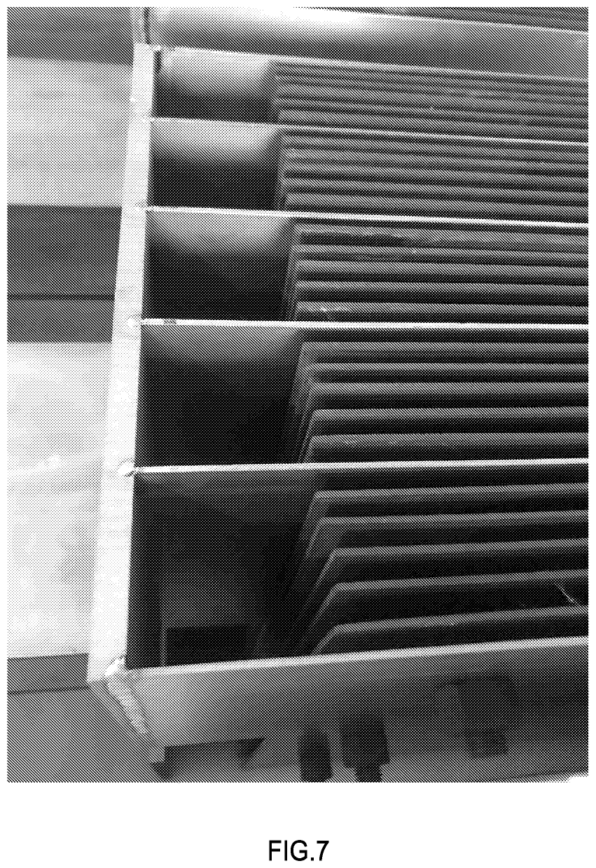

The apparatus included 10 electrolytic cells. FIGS. 5A-D show a side view, front view, top view, and combined side/front/top view of the apparatus. FIG. 6 illustrates a front view, illustrating three arrays of 10 electrolytic cells. FIG. 7 illustrates a close-up of the side of the apparatus.

### Example 1. Yield of the Chlorine Generation in Electrolytic Cell with Two Bipolar Electrodes

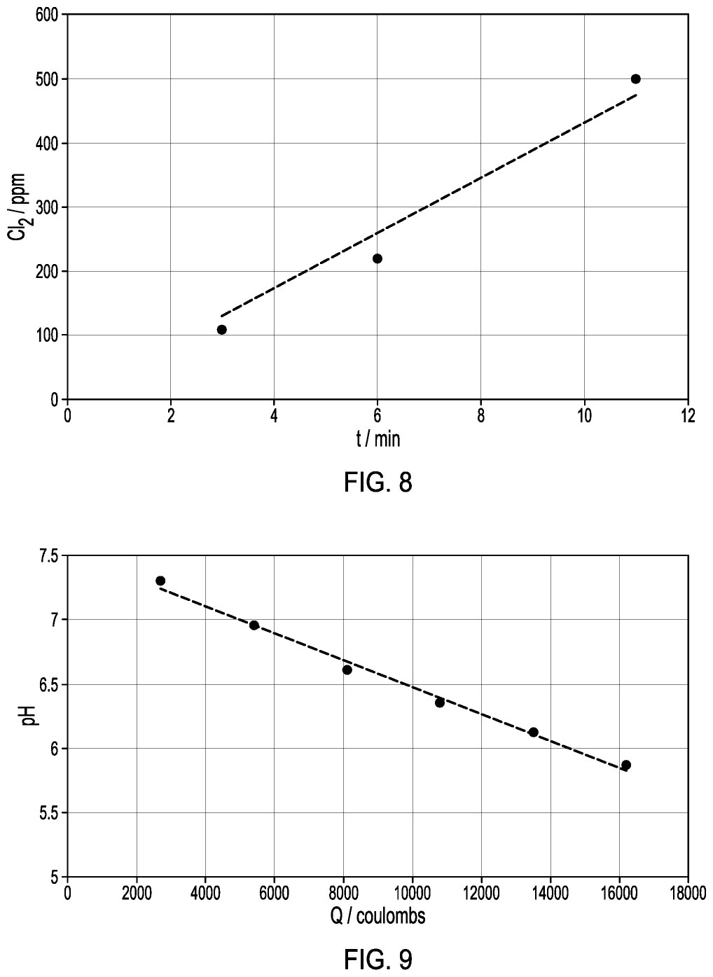

The results obtained in the electrolysis of a solution containing a chloride concentration of 6 g/L using the in the electrolytic cell are shown in FIG. 8. The conditions included I=16 Amp, E=14 V, and pH=7.3. FIG. 8 illustrates the linear variation of the chlorine concentration as a function of electrolysis time with a slope of 43 ppm Cl₂/min; this value represents 80% of the value obtained according to Faraday's equation. The results confirm that using two bipolar plates increases the amount of chlorine generated by three times as compared to electrodes of equal dimensions but with having only one bipolar plate, maintaining an efficiency of 80%, which is the maximum efficiency reported by other authors for the generation chlorine electrochemically. This efficiency value is achieved because the current density in the cell is lower than the diffusional current density for 6 g/L of chloride ions and the hydrodynamic conditions, which is impossible to achieve in an electrolytic cell lacking bipolar plates or in an electrolytic cell having only one bipolar plate.

### Example 2. Variation of the pH of Water During the Ammonia Break Point Reaction by Electrochemical Means

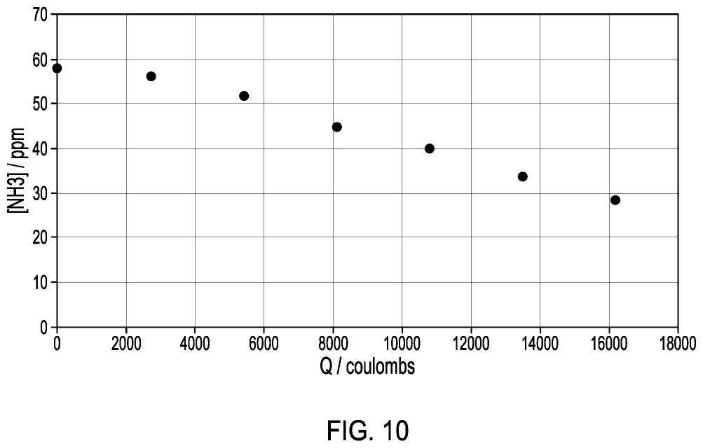

The results obtained in the electrolysis of water containing chloride and ammonia ions in the electrolytic cell are shown in FIG. 9. The conditions included initial 57.9 ppm NH₃, 6 g/L of chloride ions, I=3 Amp, and E=7.6 V. FIG. 9 shows linear drop in the pH of the water as a function of the electrical charge used in the electrolysis of the water containing ammonia. FIG. 10 shows the variation of ammonia concentration in the same range of electrical charge used in FIG. 9. The results show a correlation between the drop in the pH of the water and the decrease in the concentration of ammonia during the electrolysis process, demonstrating that the break point reaction of ammonia by the in situ electrochemical generation of chlorine leads to a decrease in the pH which can favor the generation of unwanted products such as chlorates or chloramines, which can be prevented by the implementation of a pH control tank coupled with the electrolytic cell.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides an apparatus for removal of nitrogen from water, the apparatus comprising:
an electrolytic cell comprising
   an anode;
   a cathode; and
   two or more bipolar electrodes positioned between the anode and cathode.

Aspect 2 provides the apparatus of Aspect 1, wherein the anode, the cathode, and the bipolar electrodes are each in the form of a plate that are arranged parallel to one another.

Aspect 3 provides the apparatus of any one of Aspects 1-2, where the anode plate, cathode plate, and bipolar plates each independently have a thickness of about 0.1 mm to 50 mm.

Aspect 4 provides the apparatus of any one of Aspects 1-3, wherein the anode plate, cathode plate, and bipolar plates each independently have a thickness of about 1 mm to 30 mm.

Aspect 5 provides the apparatus of any one of Aspects 1-4, wherein the anode plate, cathode plate, and bipolar plates have about the same thickness.

Aspect 6 provides the apparatus of any one of Aspects 1-5, wherein the anode, the cathode, and the bipolar electrodes are free of physical contact with one another, and wherein the anode, the cathode, and the bipolar electrodes are free of electrical connection with one another other than an optional aqueous liquid in which the electrolytic cell is immersed and an optional electrical potential applied across the anode and the cathode.

Aspect 7 provides the apparatus of any one of Aspects 1-6, wherein the electrolytic cell comprises a gap between the anode and the bipolar electrodes and a gap between the bipolar electrodes and the cathode that are each independently 0.1 mm to 20 mm.

Aspect 8 provides the apparatus of Aspect 7, wherein the electrolytic cell the gap between the anode and the bipolar electrodes and the gap between the bipolar electrodes and the cathode are each independently 0.1 mm to 5 mm.

Aspect 9 provides the apparatus of any one of Aspects 1-7, wherein the electrolytic cell comprises a gap between the bipolar electrodes that is 0.1 mm to 20 mm.

Aspect 10 provides the apparatus of Aspect 9, wherein the gap between the bipolar electrodes is 0.1 mm to 5 mm.

Aspect 11 provides the apparatus of any one of Aspects 1-10, wherein the electrolytic cell comprises an electrically non-conductive connector that physically connects the anode, bipolar plates, and cathode to one another and that maintains gaps between the anode and bipolar plates, between the bipolar plates, and between the bipolar plates and the cathode.

Aspect 12 provides the apparatus of any one of Aspects 1-11, comprising two of the bipolar electrodes positioned between the anode and cathode.

Aspect 13 provides the apparatus of any one of Aspects 1-12, comprising three or more of the bipolar electrodes positioned between the anode and cathode.

Aspect 14 provides the apparatus of any one of Aspects 1-13, wherein the anode comprises titanium, stainless steel, graphite, a conductive carbon material, or a combination thereof.

Aspect 15 provides the apparatus of any one of Aspects 1-14, wherein the anode comprises Ti.

Aspect 16 provides the apparatus of any one of Aspects 1-15, wherein the anode comprises a catalyst coating.

Aspect 17 provides the apparatus of Aspect 16, wherein the anode comprises the catalyst coating on both major faces of the anode.

Aspect 18 provides the apparatus of any one of Aspects 16-17, wherein the catalyst coating comprises one or more transition metal oxides.

Aspect 19 provides the apparatus of any one of Aspects 16-18, wherein the catalyst coating comprises TiO₂, RuO₂, IrO₂, or a combination thereof.

Aspect 20 provides the apparatus of any one of Aspects 16-19, wherein the catalyst coating comprises TiO₂:RuO₂:IrO₂.

Aspect 21 provides the apparatus of any one of Aspects 16-20, wherein the catalyst coating comprises 70:27:3 TiO₂:RuO₂:IrO₂.

Aspect 22 provides the apparatus of any one of Aspects 1-21, wherein the cathode comprises titanium, stainless steel, or a combination thereof.

Aspect 23 provides the apparatus of any one of Aspects 1-22, wherein the cathode comprises Ti.

Aspect 24 provides the apparatus of any one of Aspects 1-23, wherein the cathode is free of coatings.

Aspect 25 provides the apparatus of any one of Aspects 1-24, wherein the cathode is free of catalyst coatings, or wherein the cathode includes a catalyst coating, such as a catalyst coating comprising Cu, Ag, Co, Ni, Fe, Mo, Cu/Co, Cu/Ni, or a combination thereof (e.g., alloys thereof).

Aspect 26 provides the apparatus of any one of Aspects 1-25, wherein the bipolar electrodes comprise titanium, stainless steel, or a combination thereof.

Aspect 27 provides the apparatus of any one of Aspects 1-26, wherein the bipolar electrodes comprise Ti.

Aspect 28 provides the apparatus of any one of Aspects 1-27, wherein the bipolar electrodes are free of coatings.

Aspect 29 provides the apparatus of any one of Aspects 1-28, wherein the bipolar electrodes are free of catalyst coatings.

Aspect 30 provides the apparatus of any one of Aspects 1-29, wherein the bipolar electrodes comprise a catalyst coating.

Aspect 31 provides the apparatus of Aspect 30, wherein the bipolar electrodes comprise the catalyst coating on both major faces of each of the bipolar plates.

Aspect 32 provides the apparatus of Aspect 30, wherein the bipolar electrodes comprise the catalyst coating on one major face of each of the bipolar plates (e.g., the face that faces the nearest cathode), wherein the other major face of each of the bipolar plates is free of a catalyst coating (e.g., the face that faces the nearest anode) or comprises a catalyst coating having a different composition than the catalyst coating on the opposite face.

Aspect 33 provides the apparatus of any one of Aspects 30-32, wherein the catalyst coating comprises one or more transition metal oxides.

Aspect 34 provides the apparatus of any one of Aspects 30-33, wherein the catalyst coating comprises TiO₂, RuO₂, IrO₂, Cu, Ag, Co, Ni, Fe, Mo, Cu/Co, Cu/Ni, or a combination thereof.

Aspect 35 provides the apparatus of any one of Aspects 30-34, wherein the catalyst coating comprises TiO₂:RuO₂:IrO₂. In various aspects, the bipolar electrodes comprise a catalyst coating comprising TiO₂:RuO₂:IrO₂ on the major face of the bipolar electrode that faces the nearest cathode, and is either free of a catalyst coating on the opposite major face or comprises a catalyst coating on the opposite major face comprising Cu, Ag, Co, Ni, Fe, Mo, Cu/Co, Cu/Ni, or a combination thereof.

Aspect 36 provides the apparatus of any one of Aspects 30-35, wherein the catalyst coating comprises 70:27:3 TiO₂:RuO₂:IrO₂.

Aspect 37 provides the apparatus of any one of Aspects 1-36, wherein when an electrical potential is applied across the anode and the cathode with the electrolytic cell immersed in water comprising chloride ions, the electrolytic cell has sustained Faraday efficiency of chlorine gas production from the chloride ions of 50% to 100%.

Aspect 38 provides the apparatus of any one of Aspects 1-37, wherein when an electrical potential is applied across the anode and the cathode with the electrolytic cell immersed in water comprising chloride ions, the electrolytic cell has sustained Faraday efficiency of chlorine gas production from the chloride ions of 70% to 90%.

Aspect 39 provides the apparatus of any one of Aspects 1-38, wherein when an electrical potential is applied across the anode and the cathode with the electrolytic cell immersed in water comprising chloride and ammonium ions, the electrolytic cell is effective to remove the ammonium ions from the water in the form of nitrogen gas.

Aspect 40 provides the apparatus of any one of Aspects 1-39, wherein the apparatus comprises a plurality of the electrolytic cells.

Aspect 41 provides the apparatus of any one of Aspects 1-40, wherein the apparatus comprises 2 to 1,000 of the electrolytic cells.

Aspect 42 provides the apparatus of any one of Aspects 1-41, wherein the anode, cathode, and bipolar electrodes are a first anode, a first cathode, and first bipolar electrodes, wherein the apparatus further comprises a second electrolytic cell comprising the first cathode, two or more second bipolar electrodes, and a second anode, wherein the second bipolar electrodes are between the first cathode and the second anode.

Aspect 43 provides the apparatus of Aspect 42, wherein the apparatus further comprises a third electrolytic cell comprising the second anode, two or more third bipolar electrodes, and a second cathode.

Aspect 44 provides the apparatus of any one of Aspects 1-43, wherein the anode, cathode, and bipolar electrodes are a first anode, a first cathode, and first bipolar electrodes, wherein the apparatus further comprises a second electrolytic cell comprising the first anode, two or more second bipolar electrodes, and a second cathode, wherein the second bipolar electrodes are between the first anode and the second cathode.

Aspect 45 provides the apparatus of Aspect 44, wherein the apparatus further comprises a third electrolytic cell comprising the second cathode, two or more third bipolar electrodes, and a second anode.

Aspect 46 provides the apparatus of any one of Aspects 1-45, further comprising a pH control system that raises and/or maintains pH of water in which the electrolytic cell is immersed.

Aspect 47 provides the apparatus of Aspect 46, wherein the pH control system adds base to the water, and optionally measures pH of the water.

Aspect 48 provides an apparatus for removal of nitrogen from water, the apparatus comprising:
an electrolytic cell comprising
   an anode plate comprising titanium, wherein the anode plate comprises a catalyst coating comprising TiO₂, RuO₂, and IrO₂;
   a cathode plate comprising titanium; and
   two or more bipolar electrode plates positioned between the anode and the cathode, wherein major faces of the anode, cathode, and bipolar plates are parallel to one another, wherein each bipolar plate comprises a catalyst coating on one major face thereof that is facing the cathode plate, the catalyst coating comprising TiO₂, RuO₂, and IrO₂, and wherein the other major face of each bipolar plate is free of catalyst coatings or includes another catalyst coating having a different composition than the catalyst coating that is on the major face that is facing the cathode plate.

Aspect 49 provides an apparatus for removal of nitrogen from water, the apparatus comprising:
a first electrolytic cell comprising
   a first anode plate comprising titanium, wherein the first anode plate comprises a catalyst coating comprising TiO₂, RuO₂, and IrO₂,
   a first cathode plate comprising titanium, and
   two or more first bipolar plates positioned between the first anode plate and the first cathode plate, wherein major faces of the first anode plate, first cathode plate, and first bipolar plates are parallel to one another, wherein each first bipolar plate comprises a catalyst coating on one major face thereof that is facing the first cathode plate, the catalyst coating comprising TiO₂, RuO₂, and IrO₂, and wherein the other major face of each first bipolar plate is free of catalyst coatings or includes another catalyst coating having a different composition than the catalyst coating that is on the major face that is facing the first cathode plate; and
a second electrolytic cell comprising
   the first cathode plate,
   two or more second bipolar plates, and
   a second anode plate that comprises the catalyst coating thereon, wherein the second bipolar plates are between the first cathode plate and the second anode plate, wherein major faces of the first cathode plate, second bipolar plates, and the second anode plate are parallel to one another, wherein each second bipolar plate comprises the catalyst coating on one major face thereof that is facing the first cathode plate, and wherein the other major face of each second bipolar plate is free of catalyst coatings or includes another catalyst coating having a different composition than the catalyst coating that is on the major face that is facing the first cathode plate.

Aspect 50 provides an apparatus for removal of nitrogen from water, the apparatus comprising:
a first electrolytic cell comprising
   a first anode plate comprising titanium, wherein the first anode plate comprises a catalyst coating comprising TiO₂, RuO₂, and IrO₂,
   a first cathode plate comprising titanium, and
   two or more first bipolar plates positioned between the first anode plate and the first cathode plate, wherein major faces of the first anode plate, first cathode plate, and first bipolar plates are parallel to one another, wherein each first bipolar plate comprises a catalyst coating on one major face thereof that is facing the first cathode plate, the catalyst coating comprising TiO₂, RuO₂, and IrO₂, and wherein the other major face of each first bipolar plate is free of catalyst coatings or includes another catalyst coating having a different composition than the catalyst coating that is on the major face that is facing the first cathode plate, and
a second electrolytic cell comprising
   the first anode plate,
   two or more second bipolar plates, and
   a second cathode plate, wherein the second bipolar plates are between the first anode plate and the second cathode plate, wherein major faces of the first anode plate, second bipolar plates, and second cathode plate are parallel to one another, wherein each second bipolar plate comprises the catalyst coating on one major face thereof that is facing the second cathode plate, and wherein the other major face of each second bipolar plate is free of catalyst coatings or includes another catalyst coating having a different composition than the catalyst coating that is on the major face that is facing the second cathode plate.

Aspect 51 provides a method of removal of nitrogen from water, the method comprising:
immersing the electrolytic cell of any one of Aspects 1-48 or the plurality of electrolytic cells of any one of Aspects 49-50 in water comprising nitrogen; and
applying an electrical potential across the anode and the cathode of the electrolytic cell, to form nitrogen gas and to form product water having a lower concentration of nitrogen than the water comprising nitrogen.

Aspect 52 provides the method of Aspect 51, wherein the electrical potential generates a DC current in the electrolytic cell.

Aspect 53 provides the method of any one of Aspects 51-52, wherein the electrical potential generates an AC current in the electrolytic cell.

Aspect 54 provides the method of any one of Aspects 51-53, wherein the water comprising nitrogen comprises chloride ions and ammonium ions

Aspect 55 provides the method of any one of Aspects 51-54, wherein the water comprising nitrogen has a concentration of ammonia and/or ammonium ions of 50 ppm to 5,000 ppm.

Aspect 56 provides the method of any one of Aspects 51-55, wherein the water comprising nitrogen has a concentration of ammonia and/or ammonium ions of 150 ppm to 400 ppm.

Aspect 57 provides the method of any one of Aspects 51-56, wherein the water comprising nitrogen has a chloride concentration of 50 ppm to 40,000 ppm.

Aspect 58 provides the method of any one of Aspects 51-57, wherein the water comprising nitrogen has a chloride concentration of 200 ppm to 10,000 ppm.

Aspect 59 provides the method of any one of Aspects 51-58, further comprising adding chloride ions to the water comprising nitrogen.

Aspect 60 provides the method of Aspect 59, wherein adding chloride ions comprises adding sodium chloride, potassium chloride, or a combination thereof.

Aspect 61 provides the method of any one of Aspects 51-60, wherein the water comprising nitrogen has a pH of 4 to 12.

Aspect 62 provides the method of any one of Aspects 51-61, wherein the water comprising nitrogen has a pH of 5 to 8.

Aspect 63 provides the method of any one of Aspects 51-62, further comprising adding one or more bases to the water comprising nitrogen to regulate pH of the water.

Aspect 64 provides the method of any one of Aspects 51-63, wherein the product water has a concentration of ammonia and/or ammonium ions of 0 ppm to 2 ppm.

Aspect 65 provides the method of any one of Aspects 51-64, wherein the product water has a total nitrogen concentration, dissolved nitrogen concentration, or a combination thereof of 0 ppm to 2 ppm.

Aspect 66 provides the method of any one of Aspects 51-65, wherein the method removes 80% to 100% of ammonia and/or ammonium from the water comprising nitrogen.

Aspect 67 provides the method of any one of Aspects 51-66, wherein the method removes 99% to 100% of ammonia and/or ammonium from the water comprising nitrogen.

Aspect 68 provides the method of any one of Aspects 51-67, wherein the method reduces total nitrogen concentration, dissolved nitrogen concentration, or a combination thereof, to 0% to 70% of that of the water comprising nitrogen.

Aspect 69 provides the method of any one of Aspects 51-68, wherein the method reduces total nitrogen concentration, dissolved nitrogen concentration, or a combination thereof, to 0% to 30% of that of the water comprising nitrogen.

Aspect 70 provides the method of any one of Aspects 51-69, wherein the method further comprises contacting the product water with a galvanic cell, to form a galvanic-cell treated water.

Aspect 71 provides the method of any one of Aspects 51-70, wherein the galvanic cell comprises a cathode comprising copper and an anode comprising aluminum, wherein the method optionally comprises adding hydrogen peroxide to the product water before or during contacting of the product water with the galvanic cell.

Aspect 72 provides the method of any one of Aspects 51-71, wherein the method produces 100 ppm to 20,000 ppm of hypochlorite from chloride in the water comprising nitrogen.

Aspect 73 provides the method of any one of Aspects 51-72, wherein the method produces 2000 ppm to 2,500 ppm of hypochlorite from chloride in the water.

Aspect 74 provides the method of any one of Aspects 51-73, wherein the product water has a chloride concentration of 1 ppm to 40,000 ppm.

Aspect 75 provides the method of any one of Aspects 51-74, wherein the product water has a chloride concentration of 50 ppm to 10,000 ppm.

Aspect 76 provides the method of any one of Aspects 51-75, wherein the product water has a pH of 4 to 12.

Aspect 77 provides the method of any one of Aspects 51-76, wherein the product water has a pH of 5 to 8.

Aspect 78 provides the method of any one of Aspects 51-77, wherein the method provides a sustained Faraday efficiency of chlorine gas production from chloride ions in the water comprising nitrogen of 50% to 100%.

Aspect 79 provides the apparatus of any one of Aspects 51-78, wherein the method provides a sustained Faraday efficiency of chlorine gas production from the chloride ions of 70% to 90%.

Aspect 80 provides the method of any one of Aspects 51-79, wherein the method comprises circulating and/or agitating and/or shearing the water comprising the nitrogen in which the electrolytic cell is immersed.

Aspect 81 provides the method of any one of Aspects 51-80, wherein the method comprises flowing the water comprising the nitrogen through the cell.

Aspect 82 provides the method of any one of Aspects 51-81, wherein the method processes the water comprising nitrogen into product water at a rate of 1 GPM to 1,000,000 GPM.

Aspect 83 provides the method of any one of Aspects 51-82, wherein the method processes the water comprising nitrogen into product water at a rate of 100 GPM to 5,000 GPM.

Aspect 84 provides the method of any one of Aspects 51-83, wherein the method removes the nitrogen in the form of ammonia and/or ammonium from the water comprising the nitrogen at a rate of 0.01 kWh/kg N removed to 200 kWh/kg.

Aspect 85 provides the method of any one of Aspects 51-84, wherein the method removes the nitrogen in the form of ammonia and/or ammonium from the water comprising the nitrogen at a rate of 30 kWh/kg to 50 kWh/kg.

Aspect 86 provides the method of any one of Aspects 51-85, further comprising releasing the nitrogen gas to the atmosphere.

Aspect 87 provides the method of any one of Aspects 51-86, comprising operating the electrolytic cell with a current density of 0.001-0.1 A/cm².

Aspect 88 provides the method of any one of Aspects 51-87, comprising operating the electrolytic cell with a current density of 0.02-0.04 A/cm².

Aspect 89 provides the method of any one of Aspects 51-88, wherein the method comprises immersing a plurality of the electrolytic cells in the water comprising nitrogen.

Aspect 90 provides a method of removal of nitrogen from water, the method comprising:
immersing an electrolytic cell in water comprising nitrogen, wherein the water comprises ammonia and/or ammonium ions, and the water further comprises chloride ions, wherein the electrolytic cell comprises
   an anode plate comprising titanium, wherein the anode plate comprises a catalyst coating comprising TiO₂, RuO₂, and IrO₂;
   a cathode plate comprising titanium; and
   two or more bipolar electrode plates positioned between the anode and the cathode, wherein major faces of the anode, cathode, and bipolar plates are parallel to one another, wherein each bipolar plate comprises a catalyst coating on one major face thereof that is facing the cathode plate, the catalyst coating comprising TiO₂, RuO₂, and IrO₂, and wherein the other major face of each bipolar plate is free of catalyst coatings or includes another catalyst coating having a different composition than the catalyst coating that is on the major face that is facing the cathode plate;
applying an electrical potential across the anode plate and the cathode plate of the electrolytic cell, to form nitrogen gas and to form product water having a lower concentration of nitrogen than the water comprising nitrogen.

Aspect 91 provides a method of removal of nitrogen from water, the method comprising:
immersing an electrolytic cell in water comprising nitrogen, wherein the water comprises ammonia and/or ammonium ions, and the water further comprises chloride ions, wherein the electrolytic cell comprises
   an anode plate comprising titanium, wherein the anode plate comprises a catalyst coating comprising TiO₂, RuO₂, and IrO₂;
   a cathode plate comprising titanium, wherein the cathode plate comprises a catalyst coating comprising Cu, Ag, Co, Ni, Fe, Mo, Cu/Co, Cu/Ni, or a combination thereof, or wherein the cathode plate is free of catalyst coatings; and
   two or more bipolar electrode plates positioned between the anode and the cathode, wherein major faces of the anode, cathode, and bipolar plates are parallel to one another, wherein each bipolar plate comprises a catalyst coating on one major face thereof that is facing the cathode plate, the catalyst coating comprising TiO₂, RuO₂, and IrO₂, and wherein the other major face of each bipolar plate is free of catalyst coatings or includes another catalyst coating comprising Cu, Ag, Co, Ni, Fe, Mo, Cu/Co, Cu/Ni, or a combination thereof;
applying an electrical potential across the anode plate and the cathode plate of the electrolytic cell, to form nitrogen gas and to form product water having a lower concentration of nitrogen than the water comprising nitrogen.

Aspect 92 provides the apparatus or method of any one or any combination of Aspects 1-91 optionally configured such that all elements or options recited are available to use or select from.

What is claimed is:

1. An apparatus for removal of nitrogen from water, the apparatus comprising:
an electrolytic cell comprising
an anode;
a cathode; and
two or more bipolar electrodes positioned between the anode and cathode.

2. The apparatus of claim 1, wherein the electrolytic cell comprises a gap between the anode and the bipolar electrodes and a gap between the bipolar electrodes and the cathode that are each independently 0.1 mm to 20 mm, and wherein the electrolytic cell comprises a gap between the bipolar electrodes that is 0.1 mm to 20 mm.

3. The apparatus of claim 1, wherein the electrolytic cell comprises an electrically non-conductive connector that physically connects the anode, bipolar plates, and cathode to one another and that maintains gaps between the anode and bipolar plates, between the bipolar plates, and between the bipolar plates and the cathode.

4. The apparatus of claim 1, comprising two or more of the bipolar electrodes positioned between the anode and cathode.

5. The apparatus of claim 1, wherein the anode comprises titanium, stainless steel, graphite, a conductive carbon material, or a combination thereof, and wherein the anode comprises a catalyst coating.

6. The apparatus of claim 5, wherein the catalyst coating comprises TiO₂, RuO₂, IrO₂, or a combination thereof.

7. The apparatus of claim 1, wherein the cathode comprises titanium, stainless steel, or a combination thereof.

8. The apparatus of claim 1, wherein the bipolar electrodes comprise titanium, stainless steel, or a combination thereof.

9. The apparatus of claim 1, wherein the bipolar electrodes comprise a catalyst coating comprising TiO₂, RuO₂, IrO₂, Cu, Ag, Co, Ni, Fe, Mo, Cu/Co, Cu/Ni, or a combination thereof.

10. The apparatus of claim 9, wherein the bipolar electrodes comprise the catalyst coating on both major faces of each of the bipolar plates, wherein the catalyst coating on a major face of the bipolar plates facing the cathode comprises TiO₂, RuO₂, IrO₂, or a combination thereof, and wherein the catalyst coating on a major face of the bipolar plates facing the anode comprises Cu, Ag, Co, Ni, Fe, Mo, Cu/Co, Cu/Ni, or a combination thereof.

11. The apparatus of claim 9, wherein the bipolar electrodes comprise the catalyst coating on one major face of each of the bipolar plates, wherein the other major face of each of the bipolar plates is free of a catalyst coating.

12. The apparatus of claim 1, further comprising a pH control system that raises and/or maintains pH of water in which the electrolytic cell is immersed.

13. An apparatus for removal of nitrogen from water, the apparatus comprising:
an electrolytic cell comprising
an anode plate comprising titanium, wherein the anode plate comprises a catalyst coating comprising TiO₂, RuO₂, and IrO₂;
a cathode plate comprising titanium; and
two or more bipolar electrode plates positioned between the anode and the cathode, wherein major faces of the anode, cathode, and bipolar plates are parallel to one another, wherein each bipolar plate comprises a catalyst coating on one major face thereof that is facing the cathode plate, the catalyst coating comprising TiO₂, RuO₂, and IrO₂, and wherein the other major face of each bipolar plate is free of catalyst coatings or comprises another catalyst coating having a different composition than the catalyst coating that is on the major face that is facing the cathode plate.

14. A method of removal of nitrogen from water, the method comprising:
immersing the electrolytic cell of claim 1 in water comprising nitrogen; and
applying an electrical potential across the anode and the cathode of the electrolytic cell, to form nitrogen gas and to form product water having a lower concentration of nitrogen than the water comprising nitrogen.

15. The method of claim 14, wherein the water comprising nitrogen has a concentration of ammonia and/or ammonium ions of 50 ppm to 5,000 ppm, and wherein the product water has a concentration of ammonia and/or ammonium ions of 0 ppm to 2 ppm.

16. The method of claim 14, wherein the method removes 80% to 100% of ammonia and/or ammonium from the water comprising nitrogen.

17. The method of claim 14, wherein the product water has a total nitrogen concentration, dissolved nitrogen concentration, or a combination thereof of 0 ppm to 2 ppm, and wherein the method reduces total nitrogen concentration, dissolved nitrogen concentration, or a combination thereof, to 0% to 70% of that of the water comprising nitrogen.

18. The method of claim 14, wherein the water comprising nitrogen has a chloride concentration of 50 ppm to 40,000 ppm, and wherein the method produces 100 ppm to 20,000 ppm of hypochlorite from the chloride in the water comprising nitrogen.

19. The method of claim 14, further comprising releasing the nitrogen gas to the atmosphere.

20. A method of removal of nitrogen from water, the method comprising:
immersing an electrolytic cell in water comprising nitrogen, wherein the water comprises ammonia and/or ammonium ions, and the water further comprises chloride ions, wherein the electrolytic cell comprises
an anode plate comprising titanium, wherein the anode plate comprises a catalyst coating comprising TiO₂, RuO₂, and IrO₂;
a cathode plate comprising titanium; and
two or more bipolar electrode plates positioned between the anode and the cathode, wherein major faces of the anode, cathode, and bipolar plates are parallel to one another, wherein each bipolar plate comprises a catalyst coating on one major face thereof that is facing the cathode plate, the catalyst coating comprising TiO₂, RuO₂, and IrO₂, and wherein the other major face of each bipolar plate is free of catalyst coatings or comprises another catalyst coating having a different composition than the catalyst coating that is on the major face that is facing the cathode plate; and
applying an electrical potential across the anode plate and the cathode plate of the electrolytic cell, to form nitrogen gas and to form product water having a lower concentration of nitrogen than the water comprising nitrogen.
